(19) United States
(12) Patent Application Publication
(10) Pub. No.: US 2012/0268950 A1
(43) Pub. Date: Oct. 25, 2012

(54) Wide-Angle Non-Imaging Illumination Lens Arrayable for Close Planar Targets

(76) Inventors: William A. Parkyn, Lomita, CA (US); David G. Pelka, Huntington, CA (US)

(21) Appl. No.: 13/452,794

(22) Filed: Apr. 20, 2012

Related U.S. Application Data
(60) Provisional application No. 61/478,451, filed on Apr. 22, 2011.
(60) Provisional application No. 61/584,156, filed on Jan. 6, 2012.
(60) Provisional application No. 61/606,580, filed on Mar. 5, 2012.

(51) Int. Cl. F21V 5/04

(52) U.S. Cl. 362/335

(57) ABSTRACT

An illumination lens for hemispherically emitting light emitting diodes is disclosed that produces a circular illumination pattern of wide extent on a relatively close target. Exemplary applications are in commercial refrigerator-case lighting and in LED backlights for liquid crystal displays. This illumination lens is designed to be installed in arrays, such that the multiple patterns overlap to sum up to a nearly uniform illumination pattern. The individual lens produces an illumination ramp which monotonically declines to zero at or close to the location of the adjacent lens in the array. Design methods are disclosed whereby this illumination ramp is translated into a source-image size function that is the basis for generating any particular lens. Preferred embodiments include a cusp at the center of the outer surface. Design methods are disclosed for numerically generating the lens surfaces for any particular combination of array spacing and target distance.

### RELATED APPLICATION DATA

This application claims the priority dates of the following provisional applications: No. 61/478,451 filed on Apr. 22, 2011, entitled “Wide-Angle Non-Imaging Illumination Lens Arrayable for Close Planar Targets”, provisional application No. 61/584,156 filed on Jan. 24, 2012, entitled “Wide-Angle Non-Imaging Illumination Lens Arrayable for Close Planar Targets”, and provisional application No. 61/606,580 filed on Mar. 5, 2012, entitled “Wide-Angle Non-Imaging Illumination Lens Arrayable for Close Planar Targets”.

### BACKGROUND OF THE INVENTION

LEDs generate light in zones so small (a few mm across) that it is a perennial challenge to spread their flux uniformly over a large target zone, especially one that is much wider than its distance from the LED. So-called short-throw lighting, of close targets, is the polar opposite of spot lighting, which aims at distant targets. Just as LEDs by themselves cannot produce a spotlight beam, and so need collimating lenses, they are equally unsuitable for wide-angle illumination as well, and so need illumination lenses to do the job.

Commercial refrigerator cabinets for retail trade commonly have glass doors with lighting means installed behind the door hinges, which in the trade are called mullions. Until recent times, tubular fluorescent lamps have been the only means of shelf lighting, in spite of how cold conditions negatively affect their luminosity and lifetime. Also, fluorescent lamps produce a very non-uniform lighting pattern on the cabinet shelves. Light-emitting diodes, however, are favored by cold conditions and are much smaller than fluorescent tubes, which allow illumination lenses to be employed to provide a much more uniform pattern than fluorescent tubes ever could. Because fluorescent tubes radiate in all directions instead of just upon the shelves, much of their light is wasted. With the proper illumination lenses, however, LEDs can be much more efficient, allowing lower power levels than fluorescent tubes, in spite of the latter's good efficacy.

The prior art of LED illumination lenses can be classified into three groups, according to how many LEDs are used:

(1) Extruded linear lenses with a line of small closely spaced LEDs, particularly U.S. Pat. Nos. 7,273,299 and 7,731,395, both by this Inventor, as well as References therein.
(2) A line of a dozen or more circularly symmetric illumination lenses, such as those commercially available from the Efficient Light Corporation.
(3) A line of a half-dozen (or fewer) free-form illumination lenses with rectangular patterns, such as U.S. Pat. No. 7,674,019 by this Inventor.

The first two approaches necessarily require many LEDs in order to achieve reasonable uniformity, but recent trends in LEDs have produced such high luminosity that fewer LEDs are needed, allowing power savings. This is advantage of the last approach, but free-form lenses generating rectangular patterns have proved difficult to produce, via injection molding, with sufficient figural accuracy for their overlaps to be caustic-free. (Caustics are conspicuous small regions of elevated illuminance, generated when rays that should be parallel or diverging will instead come to a rough focus.)

What is needed instead is a circularly symmetric illumination lens that can be used in small numbers (such as five or six per mullion) and still attain uniformity, because the individual patterns are such that those few will add up to caustic-free uniformity. The objective of this Invention is to provide a lens with a circular illumination pattern that multiples of which will add up to uniformity across a rectangle. It is a further objective of this invention to attain a smaller lens size than the abovementioned approaches, leading to device compactness and resulting lower cost. The smaller lens size is achieved by a specific tailoring of its individual illumination pattern. This pattern is an optimal annulus with a specific fall-off that enables the twelve patterns to add up to uniformity between the two illuminating mullions upon which each row of six illuminators are mounted. This fall-off at the most oblique directions is important, because this is what determines overall lens size. The alternative approaches are: (1) Each mullion illuminates 100% to mid-shelf and zero beyond, which leads to the aforementioned caustics; (2) Each mullion contributes 50% at the mid-point, falling off beyond it. The latter is the approach of this Invention, and has proven highly successful.

A geometrically similar illumination application is backlights for liquid-crystal displays. Fluorescent tubes arrayed around the edge of the backlight inject their light into a waveguide, which performs the actual backlighting by uniform ejection. While fluorescent tubes are necessarily on the backlight perimeter due to their thickness, light-emitting diodes are so much smaller that they can be placed within the backlight, but their punctate nature makes uniformity more difficult, prompting a wide range of prior art over the last twenty years. Not all of this art, however, was suitable for ultra-thin (<5%) displays.

The prior art is even more challenged, moreover, when fewer LEDs are needed due to ongoing annular improvements in LED output. After all, backlight thickness is actually relative to the inter-LED spacing, not to the overall width of the entire backlight. In a 1″ thick LCD backlight with 4″ spacing between LEDs, the lens task is proportionally similar to the abovementioned refrigerator cabinet. Because of the smaller size of an LCD as compared to a 2.5 by 5 foot refrigerator door, lower-power LEDs with smaller emission area will be used, typically a Top-LED configuration with no dome-like silicone lens.

Regarding the prior art, U.S. Pat. No. 7,798,679 by Kokubo et al. shows the same cross-sectional lens profile as in FIG. 15A of U.S. Pat. No. 7,618,162 by Parkyn and Pelka, while failing to reference it. U.S. Pat. No. 7,798,679 furthermore contains only generically vague descriptions of that lens profile, and worse yet has no specific method of distinguishing the vast number of significantly different shapes fitting its vague verbiage, its many repetitively generic paragraphs notwithstanding. Experience has shown that illumination lenses are unforgiving of small shape errors, such as result from unskilled injection molding or subtle design flaws. Very small changes in local slope of a lens can result in highly visible illumination artifacts sufficient to ruin an attempt at a product. Therefore such generic descriptions are insufficient for practical use, because even the most erroneous and ill-performing lens fulfills them just as well as an accurate, high-performing lens. Thus U.S. Pat. No. 7,798,679 does not pertain to the preferred embodiments disclosed herein, because it never provides the specific, distinguishing shape-specifications whose precise details are so necessary for modern optical manufacturing.

Well-known in the field of non-imaging optics, the Simultaneous Multiple Surface (SMS) method, as disclosed in U.S. Pat. No. 6,639,733 by Mińiano & Benitez and discussed in detail in an extensive literature, generates a unique pair of surfaces which transform a pre-specified pair of input wavefronts into a pair of pre-specified output wavefronts. Nowhere in this patent or in said extensive literature, however, is any mention of how to go from a particular illumination prescription to a unique pair of output wavefronts for a lens to produce. (The input wavefronts are typically simple spherical wavefronts from opposite edges of a light source.)

Furthermore, the SMS method has in reality only ever been used to generate lenses producing narrow-angle output beams, such as for spot lights and down lights. This is because it turns out to be mathematically impossible to make any wavefronts that embody the wide-angle, short-throw illumination situation addressed by the preferred embodiments disclosed herein. The illumination lens-design method disclosed herein does use edge rays, but not wavefronts, because it lies in a different, as yet undeveloped, specialty, photometric non-imaging optics, which links source photometry with the desired target illumination in order to generate a unique lens profile. This method also yields tradeoffs of lens size vs. degree of attaining a given illumination prescription. These relatively undeveloped subjects are the basis for the novelty and precision of the preferred embodiments disclosed herein.

### SUMMARY OF THE INVENTION

Commercial refrigerator display cabinets for retail sales have a range of distances from mullion to the front of the shelves, commonly from 3″ to 8″, with the smaller spacings becoming more prevalent. Fluorescent tubes have great difficulty with the smaller spacings, leading to an acceleration of LED market share. Even though fluorescent tubes have efficacy comparable to current LEDs, their large size and omnidirectional emission hamper their efficiency, making it difficult to adequately illuminate the mid-shelf. Early LED illuminators utilized a large number of low-flux LEDs, but continuing advances in luminosity enable far fewer LEDs to be used to produce the same illuminance. This places a premium on having illumination lenses that when arrayed will sum up to uniformity while also having the smallest possible size relative to the size of the LED.

Disclosed herein are preferred embodiments that generate wide-angle illumination patterns suitable for short-throw lighting. Also disclosed is a general design method for generating their surface profiles, one based on nonimaging optics, specifically a new branch thereof, photometric nonimaging optics. This field applies the foundational nonimaging-optics idea of etendue in a new way, to analyze illumination patterns and classify them according to the difficulty of generating them, with difficulty defined as the minimum size lens required for a given size of the light source, in this case the LED.

### OBJECTIVES OF THE INVENTION

It is the first objective of this invention to disclose numerically-specific lens configurations that in arrays will provide uniform illumination for a close planar target, especially in retail refrigeration displays and in thinnest-possible backlights.

It is the second objective of this invention to provide compensation for the illumination-pattern distortions caused by volume scattering and scattering of Fresnel reflections, which together act as an additional, undiscriminating light source.

On fulfillment of the inventor's duty to go beyond superficial description, it is the third objective of this invention to disclose fully the design methods that generated the preferred embodiments disclosed herein, such that those skilled in the art of illumination optics could design further preferred embodiments for other illumination applications, in furtherance of the ultimate objective of the patent system to expand public knowledge.

### BRIEF DESCRIPTION OF THE DRAWINGS

The above and other aspects, features and advantages of the present invention will be apparent from the following more particular description thereof, presented in conjunction with the following drawings wherein:

FIG. 1 shows how a rectangular door is illuminated by lenses producing circular illumination patterns.

FIG. 2 shows a graph of an individual circular illumination pattern.

FIG. 3 shows an end view of the door of FIG. 1, with slant angles.

FIG. 4 shows a graph of required source magnification.

FIG. 5 shows a cross-section of an illumination lens and LED.

FIG. 6A-6F show source-image rays from across the target.

FIG. 7 shows how a rectangular door is illuminated by only 4 LEDs.

FIG. 8 shows a cross-section of a further illumination lens and LED.

FIG. 9 illustrates a mathematical description of volume scattering.

FIG. 10 is a graph of illumination patterns.

FIG. 11 sets up a 2D source-image method of profile generation.

FIG. 12 shows said method of profile generation.

FIG. 13A and 13B show the 3D source-image method of profile generation.

FIG. 14 shows a concave-plano lens-center, with defining rays.

FIG. 15 shows a concave-concave lens-center, with defining rays.

FIG. 16 shows a plano-convex lens-center, with defining rays.

FIG. 17 shows the complete lens made from the lens-center of FIG. 14.

FIG. 18 shows the complete lens made from the lens-center of FIG. 15.

FIG. 19 shows the complete lens made from the lens-center of FIG. 16.

FIG. 20 shows a convex-convex lens center, with defining rays.

FIG. 21 shows an early stage in the design of the full lens.

FIG. 22 shows a later stage of same.

FIG. 23 shows the complete lens made from the lens center of FIG. 20.

FIG. 24 shows the illumination pattern of same.

FIG. 25 shows the Bezier method of constructing an arbitrary parabola.

### DETAILED DESCRIPTION OF THE PREFERRED EMBODIMENTS

A better understanding of the features and advantages of the present invention will be obtained by reference to the following detailed description of the invention and accompanying drawings, which set forth illustrative embodiments in which the principles of the invention are utilized.

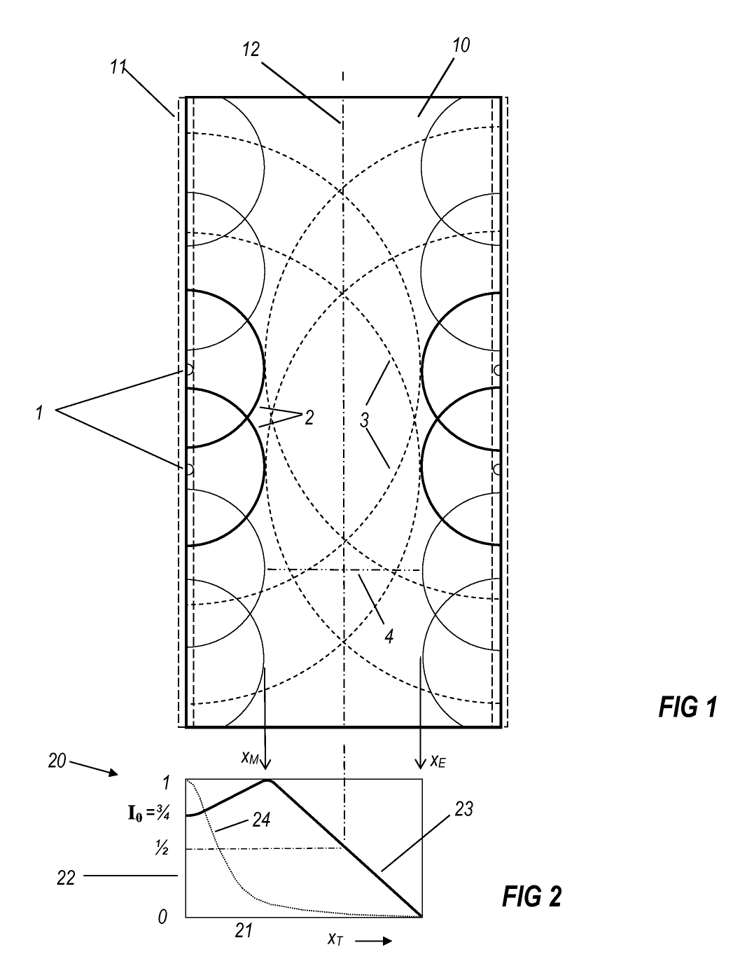

FIG. 1 shows rectangular outline 10 representing a typical refrigerator door that is 30″ wide and 60″ high, with other doors, not shown, to either side. Dashed rectangles 11 denote the mullions behind which the shelf lighting is mounted, typically at 3-6″ from the front of the illuminated shelves. This is much closer than the distance to the shelf center, denoted by centerline 12. There are twelve illuminators (six on either side), four of which are denoted by small circles 1. Each illuminator produces an illuminated circle with its peak on a ring denoted by solid circles 2 and its edge on dotted circles 3. Here the circles 2 have radius of a quarter of the shelf width, or halfway to centerline 12. The circles 3, where illuminance has fallen to zero, are sized to meet the circles 2 from the opposite mullion.

FIG. 2 shows graph 20 with abscissa 21 for lateral coordinate x_{T} that is horizontally scaled the same as FIG. 1 above it. Ordinate 22 is scaled from 0 to 1, denoting the ideal illuminance I(x), as graphed by curve 23, generated on the shelves by an illuminator under the mullion. This illumination function is relative to the maximum on circle 2, which has radius x_{T}=xₘ. It falls off to zero at radius x_{T}=x_{E}. This gradually falling illuminance is paired with the gradually ascending one of the illuminator on the opposite side of the door, so the two patterns add up to constant illuminance along the line 4 of FIG. 1.

An actual injection-molded plastic lens will exhibit volume scattering within its material, making the lens itself an emitter rather than a transmitter. This volume scattered light will be strongest just over the lens. The central dip in the pattern 23, shown in FIG. 2 to be at the ¾ level, compensates for this extra volume-scattered light, so that the total pattern (direct plus scattered) is flat within circle 2. This effect becomes more pronounced with the larger lenses discussed below.

Another advantage of this type of gradually falling-off pattern is that any point on centerline 12 is lit by several illuminators on each mullion, assuring good uniformity. The dotted curve 24 shows the illumination pattern of an LED alone. It is obviously incapable of adding up to satisfactory illumination, let alone uniform, hence the need for an illumination lens to spread this light out properly.

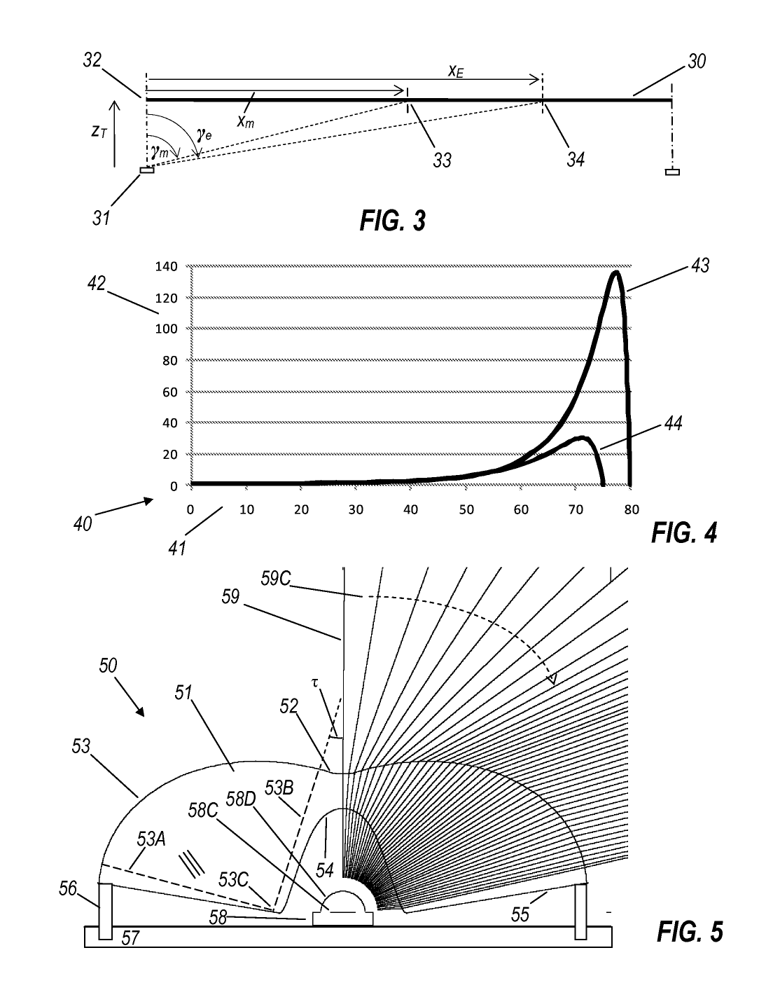

FIG. 3 shows an end view of shelf-front rectangle 30 identical to that of FIG. 1. Illuminators are located as shown by small rectangles 31. The strategy of this invention addresses the difficulty of lighting from so close to the shelf, in this case at a distance of z_{T}=4″. FIG. 3 shows the distances xₘ=15″ and x_{E}=22.5″, respectively, to centerline 33 and edge-line 34, at which the pattern of illuminator 31 has reached zero illuminance. These distances correspond to off-axis angles from the normal given by

γₘ=tan^{—1}(xₘ/z_{T})=tan⁻¹(15/4)=75° γ_{E}=tan⁻¹(x_{E}/z_{T})=tan⁻¹(22.5/4)=80°

These large slant-angles drive the lens design, requiring considerable lateral magnification of the source by the lens. At low slant-angles, in contrast, the lens must demagnify.

This concept of magnification and demagnification can be made more explicit via etendue considerations. The source-etendue is that of a chip of area A_{S}=2.1 mm², immersed in a dome of refractive index n=1.45:

E_{S}=πn²A_{S} sin² θ=14 mm²

Here θ is 90° for a Lambertian source.

An illumination lens basically redistributes this etendue over the target, which is much larger than the chip. In the case of the illumination pattern in FIG. 2, the target etendue relates to the area A_{T} of the 45″ illumination circle of FIG. 1, as weighted by the relative illumination function 23 of FIG. 2. This simple model of an actual illumination pattern has a central dip to illuminance I₀, a rise to unity at x_{T}=x_{M}, and a linear falloff to zero at x=x_{E}. This is mathematically expressed as

I(x)=I₀+x(1−I₀)/x_{M} x≦x_{M}

I(x)=(x_{E}−x)/(x_{E}−x_{M}) x_{M}≦x≦x_{E}

Then the target etendue is given by an easily solved integral:

$${E}_{T} = π {sin}^{2} {θ}_{T} {\int }_{0}^{xe} 2 π xI ( x ) d x = 2 {π}^{2} {sin}^{2} {θ}_{T} ( {[ \frac{{I}_{0} {x}^{2}}{2} + \frac{( 1 - {I}_{0} ) {x}^{3}}{3 {x}_{M}} ]}_{0}^{{x}_{M}} + {[ \frac{{x}_{E}}{2 ( {x}_{E} - {x}_{M} )} {x}^{2} - \frac{{x}^{3}}{3 ( {x}_{E} - {x}_{M} )} ]}_{{x}_{M}}^{{x}_{E}} )$$

$${E}_{T} = {sin}^{2} {θ}_{T} 1.47 square meters$$

Here θ_{T} is the half angle of a narrow-angle collimated beam with the same etendue as the source, so that

sin² θ_{T}˜1E−5 θ_{T}=±0.18°

At the center of the lens this is reduced by ¾, to ±0.13°. This can be contrasted with the angular subtense of the source alone, as seen from directly above it on the shelf, at distance z_{T} as shown in FIG. 3:

tan² θ_{S}=n²A_{C}/4z_{T}² θ_{S}=±0.61°

Thus the central demagnification of the lens needs to be 1:4.5, dictating that the central part of the lens be concave, in order to act as an expander with negative focal length. This can be attained on a continuum of concavity bounded by a flat-topped outer surface with a highly curved inside surface or a flat-topped inner surface with the outer surface highly curved. That of FIG. 5 lies between these extremes.

As shown in FIG. 3, a high slant angle γ means that to achieve uniform illumination the source image made by the lens must be correspondingly larger than for normal incidence, by a factor of 1/cos γ. The source itself will be foreshortened by a slant factor of cos γ, as well as looking smaller and smaller by being viewed from farther away, by a further factor of cos² γ. Thus the required lens magnification is

$$M ( γ ) = \frac{1}{4.5 {cos}^{4} γ}$$

Note that magnification rises from ¼ on-axis to unity at an off-axis angle given by

$$γ ( M ) = {cos}^{- 1} \sqrt[4]{\frac{1}{4.5 M}} γ ( 1 ) = 47 °$$

These angles dilute the illuminance by a cosine-cubed factor, so that the farther out light must be thrown, the more intense must be the lens output. Considering that the LED source has a cosine fall-off of its own, the total source magnification required is the well-known cos⁻⁴ factor, amounting to 223 at 75° 1100 at 80°, respectively. Here lies the advantage of the fall-off in the illumination pattern of FIG. 2, since these deleterious factors are reduced accordingly.

FIG. 4 shows graph 40 with abscissa 41 running from 0 to 80° in off-axis angle γ and ordinate 42 showing the source magnification M(γ) required for uniform illumination. Unit magnification is defined as a source image the same size as if there were no lens. What this magnification means is that the illumination lens of the present invention must produce an image of the glowing source, as seen from the shelf, that is much bigger than the Lambertian LED source without any lens. For uniformly illuminating a 4″ shelf-distance, curve 43 shows that the required magnification peaks at 77.5°, while lower curve 44 is for the much easier case of a 6″ shelf distance, peaking at 71°. This required image-size distribution is the rationale for the configuration of the present invention.

FIG. 5 is a cross-section of illuminator 50, comprising illumination lens 51, bounded by an upper surface comprising a central spherical dimple with arc 52 as its profile and a surrounding toroid with elliptical arc 53 as its profile, and also bounded by a lower surface comprising a central cavity with bell-shaped profile 54 and surrounding it an optically inactive cone joining the upper surface, with straight-line profile 55 and pegs 56 going into circuit board 57. Illuminator 50 further comprises LED package 58 with emissive chip 58C immersed in transparent hemispheric dome 58D. The term ‘toroid’ distinguishes from the conventional term ‘torus’, which solely covers the case of zero tilt angle. The highly oblique lighting setup of refrigerator-cabinet shelf-fronts quite understandably involves tilting the torus so that the lensing effect of the elliptical arc points toward the center of the shelf.

Arc 52 of FIG. 5 extends to tilt angle τ, which in this case is 17°, its importance being that it is the tilt angle of major axis 52A of elliptical arc 52. Its minor axis 52B lines up with the radius at the edge of arc 51, ensuring profile-alignment with equal surface tangency. There are three free parameters which define a particular outer surface of illumination lens 51, as intended for different shelf distances. The first is the radius of arc 52, which controls the amount of de-magnification by the central portion of illumination lens 51. The second is the tilt angle τ, which defines the orientation of elliptical arc 53, namely towards the shelf center of FIG. 1. The third free parameter of the upper surface is the ratio of major axis 53A to minor axis 53B, in this case 1.3:1, defining the above-discussed source magnification. Ray-fan 59 comprises central rays (i.e., originating from the center of chip 58C) at 2° intervals of off-axis angle. The central ten rays designated by dotted arc 59C illustrate the diverging character of the center of lens 51, which provide the central demagnification required for uniform illumination. The remaining rays are all sent at steep angles to the horizontal, providing the lateral source magnification of FIG. 4.

The central cavity surrounding LED 58 has bell-shaped profile 54 defined by the standard aspheric formula for a parabola (i.e., conic constant of −1) with vertex at zᵥ, vertex radius of curvature r_{c}, 4^{th}-order coefficient d and 6^{th}-order coefficient e:

z(x)=zᵥ+x/r_{c}+dx⁴+ex⁶

In order for profile 54 to arc downward rather than upward, the radius of curvature r_{c} is negative. The aspheric coefficients provide an upward curl at the bottom of the bell, to help with cutting off the illumination pattern. The particular preferred embodiment of FIG. 5, with a cavity entrance-diameter set at 6.45 mm, is defined by:

zᵥ=6 mm r_{c}=−1.69 mm d=−0.05215 e=0.003034

This profile only needs minor modification to be suitable for preferred embodiments illuminating other shelf distances.

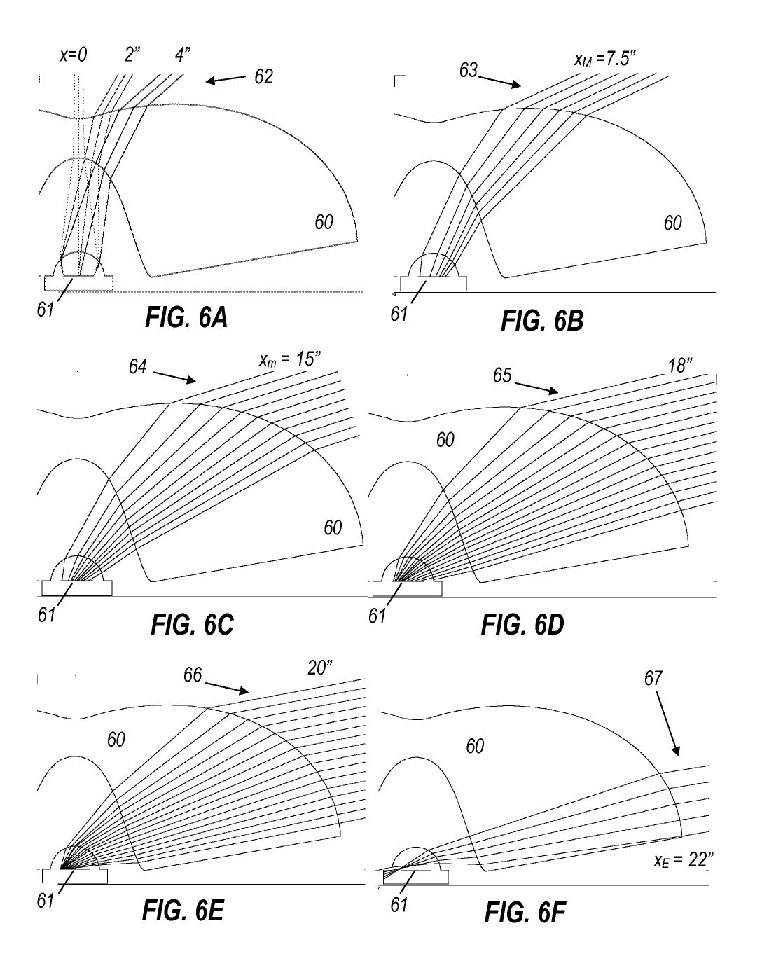

FIG. 6A through 6F shows illumination lens 60 and LED chip 61. In FIG. 6A, rays 62 come from points on the shelf at the indicated x coordinates of 0, 2″, and 4″ laterally from the lens. Each bundle is just wide enough that its rays end at the edges of chip 61, which is the definition of a source image. Each bundle is narrower than chip 61 would appear by itself, in accordance with the previously discussed demagnification. The central portion of lens 60 that is traversed by rays 62 can be seen to be a concave, diverging lens, as previously mentioned.

FIG. 6B shows ray bundle 63 proceeding from the distance x_{M} to the maximum of the illumination pattern in FIG. 2. It is twice the width of those in FIG. 6A.

FIG. 6C shows ray bundle 64 proceeding from the distance xₘ to the middle of the shelf, as shown in FIG. 2.

FIG. 6D shows ray bundle 65 proceeding from beyond mid shelf, at 18″.

FIG. 6E shows ray bundle 66 proceeding from beyond mid shelf, at 20″, nearly filling the lens. This is the maximum source magnification this sized lens can handle.

FIG. 6F shows ray bundle 67 proceeding from the edge of the illumination pattern, at x_{E}=22″. Note that these rays miss chip 61, indicating that there will be no light falling there, which is required by the pattern cutoff.

The progression of FIG. 6A through 6F is the basis for the numerical generation of the upper and lower surface profiles of the lens, starting at the center and working outwards, as will be disclosed below. The results of this method can sometimes be closely approximated by the geometry of FIG. 5.

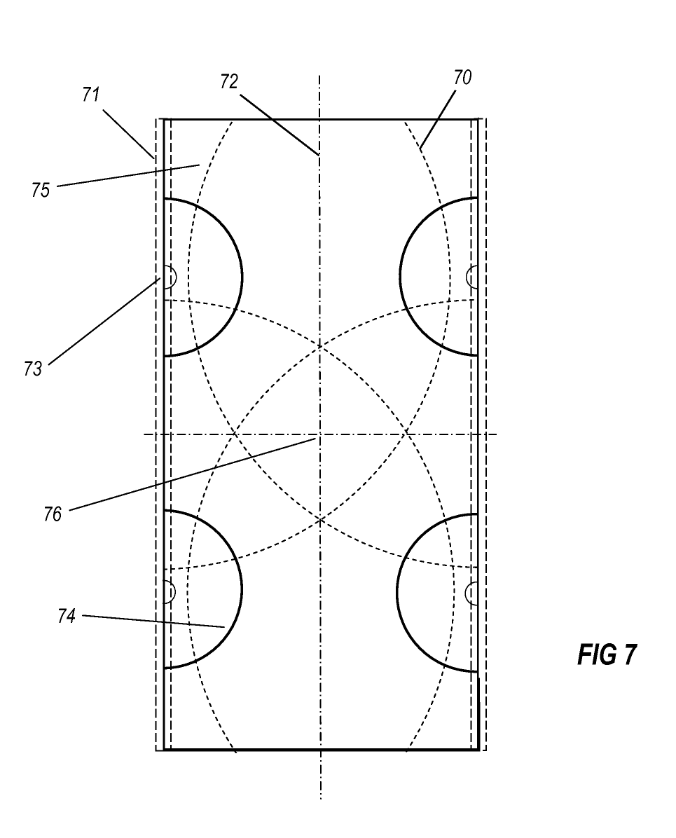

The illumination lens of FIG. 5 has elliptical and aspheric-parabolic surfaces with shapes that are exactly replicable by anyone skilled in the art. In the illumination pattern of FIG. 2, the central depression to ¾ the maximum value was empirically found to work with the lens array of FIG. 1, with six lenses on each side. This lens is the first commercially available design enabling only six LEDs to be used, rather than the dozen or more of the prior art. More recently, however, even higher-power LEDs have become available that only require two per door, as FIG. 7 illustrates.

FIG. 7 shows rectangular outline 70 representing a typical refrigerator door that is 30″ wide and 60″ high, with other doors, not shown, to either side. Dashed rectangles 71 denote the mullions behind which the shelf lighting is mounted, typically at 3-6″ from the front of the illuminated shelves. This is much closer than the distance to the shelf center, denoted by centerline 72. There are four illuminators (two on either side), denoted by small circles 73. Each illuminator produces an illuminated circle with its peak on a ring denoted by solid circles 74 and its edge on dotted circles 75. Here the circles 74 have radius of about a fifth of the shelf width, or a third the way to centerline 72. The circles 75, where illuminance has fallen to zero, are sized to reach nearly all the way across the shelf. As in FIG. 1, each pattern has the value ½ at centerline 72, so two lenses add to unity. Also, at shelf center-point 76 the four patterns overlap, so at this distance each pattern must have the value ¼, and thus add to unity. This same configuration is applicable for LCD backlights comprising square-arrayed LEDs, merely on a smaller scale. This arrangement of precisely configured illumination lenses is capable of generating uniformity satisfactory for LCD backlights.

The LEDs used in the arrangement of FIG. 7 must be three times as powerful as those used for FIG. 1. This greater flux has unwanted consequences of triply enhanced scattered light, strengthened even more by the greater size of the lenses used for FIG. 7 versus the smaller ones which would suffice for FIG. 1. The illumination pattern of FIG. 2 has a central dip in order to compensate for the close spacing of the lenses. When scattering is significant, however, the scattered light can be strong enough to provide all the illumination near the lens. The upshot is that the illumination pattern shown in FIG. 2 would have nearly zero intensity on-axis. The resultant lens has a previously unseen feature: either or both surfaces have a central cusp that leaves no direct light on the axis, resulting in a dark center for the pattern, in order to compensate for the scattered light.

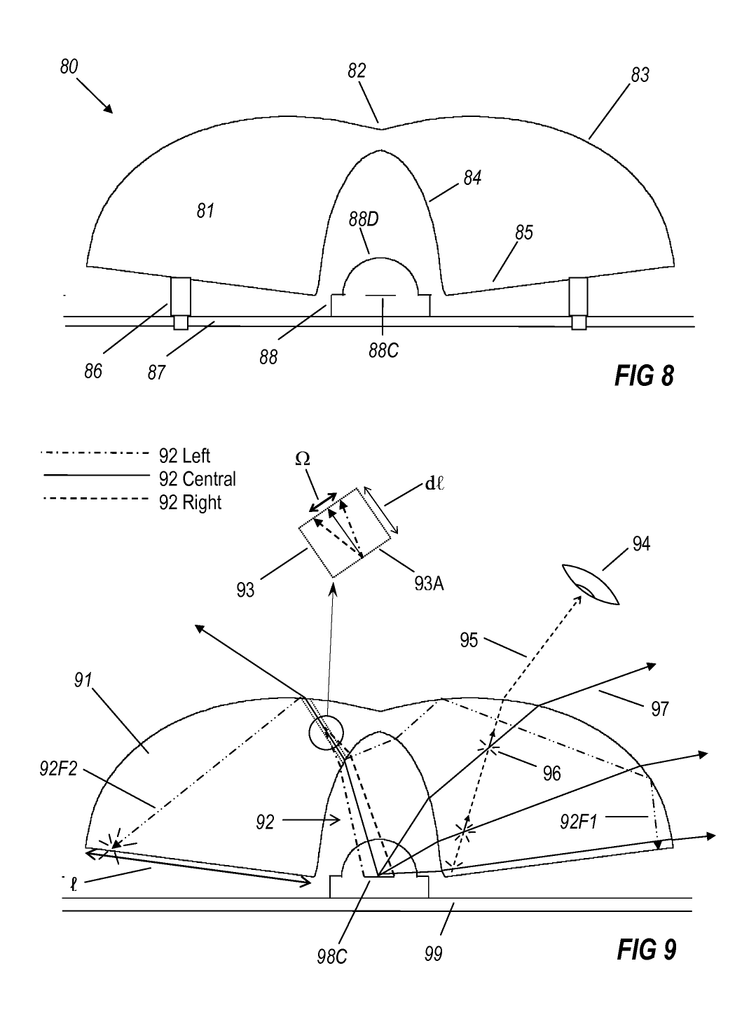

FIG. 8 is a cross-section of illuminator 80, comprising circularly symmetric illumination lens 81, bounded by an upper surface comprising a central cusp 82 formed by a surrounding toroid with tailored arc 83 as its profile. Lens 81 is also bounded by a lower surface comprising a central cavity with tailored profile 84 preferably peaking at its tip, and surrounding it an optically inactive cone joining the upper surface, with straight-line profile 85 and pegs 86 going into circuit board 87. Illuminator 80 further comprises centrally located LED package 88 with emissive chip 88C immersed in transparent hemispheric dome 88D.

The optically active profiles 83 and 84 of FIG. 8 are said to be tailored due to the specific numerical method of generating it from an illumination pattern analogous to that of FIG. 2, but with little or no on-axis output. The reason for this is, as aforementioned, to compensate for real-world scattering from the lens. The profiles 83 and 84 only control light propagating directly from chip 83C, through dome 83D, and thence refracted to a final direction that ensures attainment of the required illumination pattern. This direct pattern will be added to the scattering pattern of indirect light, which thus needs to be determined first.

FIG. 9 shows illumination lens 91, identical to lens 81 of FIG. 8, with other items thereof omitted for clarity. From LED chip 98C issues ray bundle 92, comprising a left ray (dash-dot line), a central ray (solid line), and a right ray (dashed line), issuing respectively from the left edge, center, and right edge of LED chip 98C. Anywhere within lens 91, these rays define the apparent size of chip 98C and thus how much light is passing through a particular point. Any light scattered from such a point will be a fixed fraction of that propagating light. The closer to the LED the more light is present at any point, and the greater the amount scattered. This scattering gives the lens its own glow, separate from the brightness of the LED itself when directly viewed.

Strictly speaking, scattering does not take place at a point but within a small test volume, shown as infinitesimal cube 93 in FIG. 9, magnified for clarity. It is oriented along the propagation direction of ray bundle 92. It has cross-section 93A of area dA and propagation length dl, such that its volume is simply dV=dldA. Within cube 93 can be seen the left, central, and right rays of bundle 92, now switched sides. The right and left rays define solid angle Ω, indicating the apparent angular size of LED chip 98C as seen from cube 93 within lens 91. The greater this solid angle the more light will be going through cube 93. LED chip 98C has luminance L, specified in millions of candela per square meter. This is reduced when ray bundle 92 goes into lens 91, due to less-than-unity transmittance τ caused by Fresnel reflections. Going into cube 93 the ray bundle 92 has intensity I given simply by I=τLdA. The total flux F passing through cube 93 is then given, simply again, by F=IΩ.

Volume scattering removes a fixed fraction of this intensity I per unit length of propagation, similar to absorption. Both are described by Beer's law:

I/(l)=I(0)e^{-κl}

Here I(0) is the original intensity and I(l) is what remains after propagation by a distance l, while scattering coefficient κ has the dimension of inverse length. It can easily be determined by measuring the loss in chip luminance as seen through the lens along the path l of FIG. 9.

Returning to cube 93 of FIG. 9, the ingoing intensity I is reduced by the small amount dI=e^{-κdl}. This results in a flux decrement dF=dIΩ that is subtracted from F. Then the emission per unit volume is dF/dV. Integrating this over the entire optically active volume of lens 91 gives the total scattered light. FIG. 9 further shows observer 94 gazing along line of sight 95, along which direct rays 97 give rise to scattering points 96, summing into a lens glow that acts as a secondary light source surrounding the LED.

These scattering phenomena are usually looked upon as disadvantageously parasitic, acting only to detract from optical performance. There is a new aspect to this, however, where some volume scattering would be beneficial. It arises in the subtle failings of current high-brightness LEDs, namely that of not delivering the same color in all directions. More specifically, many commercially available LEDs with multi-hundreds of lumens output look much yellower when seen laterally than face-on. This is because of the longer path through the phosphor taken by light from the blue chip.

Thick phosphors have uniform whiteness, or color temperature, in all directions, but they reduce luminance due to the white light being emitted from a much bigger area than that of the blue chip. Conformal coatings, however, are thin precisely in order to avoid enlarging the emitter, but they will therefore scatter light much less than a thick phosphor and therefore do much less color mixing. As a result, lateral light is much yellower (2000 degrees color temp) and the face-on light much bluer (7000 degrees) than the mean of all directions. As a result of this unfortunate side-effect of higher lumen output, the lenses disclosed herein will exhibit distinct yellowing of the lateral illumination, and a distinct bluing of the vertical illumination.

The remedy for this inherent color defect is to use a small quantity of blue dye in the lens material. Since the yellow light goes through the thickest part of the lens, the dye will automatically have its strongest action precisely for the yellowest of the LEDs rays, those with larger slant angles. The dye embedded in the injection-molding material should have an absorption spectrum that only absorbs wavelengths longer than about 500 nm, the typical spectral crossover between the blue LED and the yellow phosphor. The exact concentration will be inversely proportional to lens size as well as to the absorption strength of the specific dye utilized.

A further form of scattering arises from Fresnel reflections, aforementioned as reducing the luminance of rays as they are being refracted. FIG. 9 further shows first Fresnel-reflected ray 92F1 coming off the inside surface of lens 91, then proceeding into the lens to be doubly reflected out of the lens onto circuit board 92F1. This ray has strength of (1−τ) relative to the original ray 92. Of similar strength is the other Fresnel-reflected ray, 92F2, which proceeds from the outer surface to the bottom of the lens. These two rays are illustrative of the general problem of stray light going where it isn't wanted. Unlike the volume scattering at points 96, these Fresnel-reflected rays can travel afar to produce displeasing artifacts. It has been well-known for many decades of optical engineering that the easiest way to deal with this is to institute surface scattering of these stray rays. Since the flat conical bottom surface 91C of lens 91 intercepts most of these stray Fresnel reflections, the tried-and-true traditional solution is simply to roughen the corresponding mold surface so that the Fresnel light is dissipated to become part of the above-described volume scattering. At the termination of ray 92F2 can be seen the scattered rays, some of which illuminate the top of board 99, which of course would also be scattering, such as by white paint.

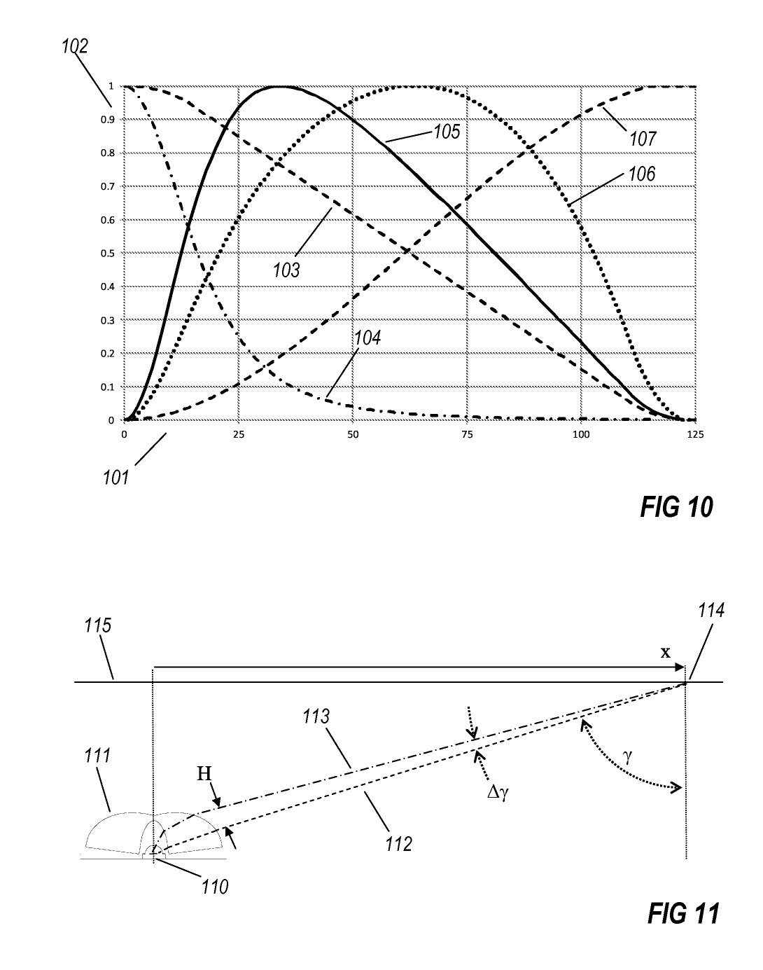

FIG. 10 shows graph 100 with abscissa 101 denoting distance in millimeters from the center of the lens of FIG. 9 and ordinate 102 denoting illuminance relative to the pattern maximum (in order to generalize to any illumination level). Dashed curve 103 is an illumination pattern with a central maximum of unity and continuous slope to zero illuminance at 125 mm. Dashed curve 107 is the area-weighted cumulative distribution of encircled flux of curve 103, as discussed below. Dashed curve 103 is the ideal illumination pattern desired for the configuration of FIG. 7, given an inter-lens spacing of 125 mm and a target distance of 23 mm. These dimensions represent a backlight application, where the LEDs are arrayed within a white-painted box, and the target is a diffuser screen, with a liquid-crystal display (LCD) just above it. Increased LED luminosity mandates fewer LEDs, to save on cost, while aesthetic considerations push for a thinner backlight. These two factors make for a design-pressure towards very short-throw lighting.

The ‘conical pattern’ of curve 103 and the mirror image curve (not shown) for the adjacent lens 125 mm away will add to unity, which assures uniform illumination. Dash-dot curve 104 is an idealized version of the combined parasitic illuminance on that target plane caused by the above-discussed volume and surface scattering from a lens at x=0. This curve is basically the cosine⁴ of the off-axis angle to a point on the target. Solid curve 105 is the normalized difference between the other two curves, representing the pattern that when scaled will add to curve 104 to get a total illuminance following curve 103. In this case the scattered light of curve 104 is strong enough to deliver 100% of the required illuminance just above the lens. In such a case the central cusp 82 of FIG. 8 will ensure that the central illuminance is zero when only counting direct light that is delivered through the lens.

The illumination pattern represented by curve 105 of FIG. 10 can be used to numerically generate the inner and outer profiles of the lens 81 of FIG. 8, utilizing rays from the right and left edges of the source. Dotted curve 106 of FIG. 10 graphs the relative size of the source image height (as shown in FIG. 6A-F) required by the illuminance pattern of curve 105. This height function is directly used to generate the lens profiles.

FIG. 11 shows LED 110 and illumination lens 111, of 20 mm diameter, sending right ray 112 and left ray 113 to point 114, which has coordinate x on planar target 115, located 23 mm above LED 110. Right ray 112 hits point 114 at slant angle γ, and left ray 113 at slant angle γ+Δγ. In the two-dimensional analysis of FIG. 11, the illuminance l(x) at point x is proportional to the difference between the sines of the left and right rays' slant angles:

l(x)α sin(γ+Δγ)−sin(γ)

This angular requirement can be met by the proper height H of the source image, namely the perpendicular spacing between right ray 112 and left ray 113, at the lens exit of 112. Curve 106 of FIG. 10 is a plot of this height H, relative to its maximum value. From this geometric requirement the lens profiles can be directly generated by an iterative procedure that adds new surface to the previously generated surface.

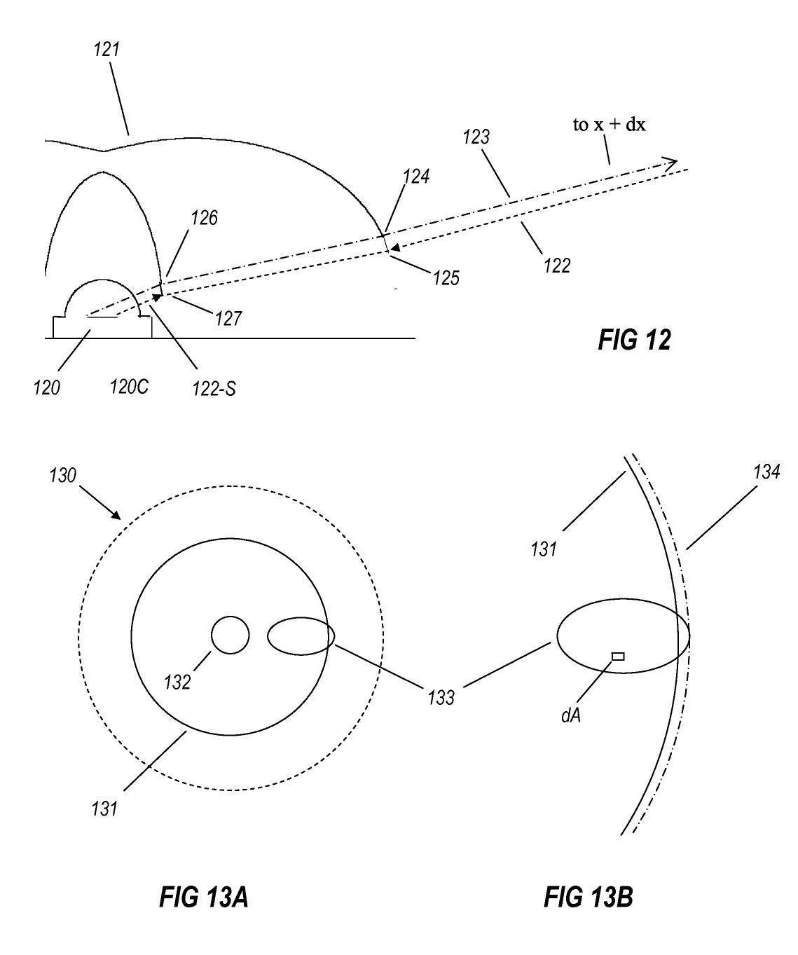

FIG. 12 shows incomplete illumination lens 121, positioned over LED 120. It is incomplete in that it represents a typical iteration-stage of a three-dimensional method generating the entire lens of FIG. 11. The portion of Lens 111 of FIG. 11 that is shown as a slightly thickened curve terminates at its intersection, shown as point 124, with right ray 122. In FIG. 12, a new left ray 123 is launched that is barely to the right of left ray 113 of FIG. 11. After going through terminal point 126 and then through previously generated upper surface 121, it will intercept the target (not shown) at a new point x+dx, just to the right of point x of FIG. 10. This point will have an already calculated source-height requirement such as curve 105 of FIG. 19, fulfilled by launching a new right ray 122 from x+dx. Ray 122 will intercept the lens surface at point 125, upon new surface that has been extended from point 124. The new surface has a slope determined by the necessity to deflect ray 122 towards point 126 on the interior surface of lens 121. The location of this point 127 is determined by right ray 122-S coming from the right edge of LED chip 120C. The off-axis angle of this ray is determined by the usual requirement that the angular-cumulative intensity of right ray 122S equal the spatially cumulative illumination at point x+dx, which is known from the desired illumination pattern, such as that shown by curve 105 of FIG. 10. The slope of this new interior surface, from point 126 to new point 127, is determined by the necessity of refracting ray 122S so it joins ray 122 to produce the proper source-image height for the illumination of the target at point x+dx. In this fashion, the generation of lens 121 will be continued until all rays from chip 120C are sent to their proper target coordinates, and its full shape is completed.

The profile-generation method just described is two-dimensional and thus does not account for skew rays (i.e., out-of-plane rays), which in the case of a relatively large source can give rise to noticeable secondary errors in the output pattern, due to lateral variations in the size of the source image. This effect necessitates a fully three-dimensional source-image analysis for generating the lens shape, as shown in FIG. 13.

The lens-generation method of FIG. 12 traces left ray 123 through the previously generated inner and outer surfaces to a target point with lateral coordinate x+dx. The pertinent variable is the height H of the source image. In three dimensions, however, rays must be traced from the entire periphery of the LED's emission window out to the target point, where they limn the image of the source as seen through the lens from that point. An illumination lens acts to alter the sources' apparent size from what it would be by itself. The projected (i.e., cosine-compensated) size of the source image is what determines how much illumination the lens will produce at any target point.

FIG. 13A is a schematic view from above of circular illumination lens 130, with dotted lines showing is incomplete, its design iteration having only extended so far to boundary 131. Circular source 132 is shown at the center of lens 130, and oval 133 represents the source image it projects to target point x+dx (not shown). This source image is established by reverse ray tracing from the target point back through the lens to the periphery of the source. The source image is the oval outline 133 on the upper surface where these rays intercept it. Thus the already completed part of the lens will partially illuminate the target point, and a small element of new surface must be synthesized for full illumination.

FIG. 13B is a close-up view showing source ellipse 133 and boundary 131, also showing curve 134, representing a small element of new surface that will be added in order to complete source image 133 and achieve the desired illumination level at target point x+dx. Of course, when new upper surface is added there will have to be a corresponding element of new lower surface added as well. Just as there must be enough new upper surface to finish the source image, so too must there be enough lower surface to provide the source image to the upper surface. Since both the extent and slope of this new lower surface must be determined as free variables, the design method must be able to calculate both unknowns, but in general the slopes of the new elements of upper and lower surface will be smooth continuations of the previous curvatures of the surfaces.

Traditionally, non-imaging optics deals only with rays from the edge of the source, but the illumination lenses disclosed herein go beyond this when assessing the source image at each target point. The incomplete source image of FIG. 13B gives rise to a less-than-required illuminance at the target point of interest, at lateral coordinate x_{T} thereupon. In order to calculate this illuminance, however, rays must be reverse-traced back to the entire source, not just its periphery. This is especially true when the source has variations in luminance and chrominance. Then the flux from each small elemental area dA of FIG. 13B is separately calculated and integrated over the source image as seen through already completed surface. As each increment of new surface is added, it will bring into view further portions of the source, as it enlarges the source image and brings the illuminance up to the desired value. The deficit from the required illuminance will then be made up by the new surface 134 of FIG. 13B. Its size is such that the additional source image area will just finish the deficit. When the illumination pattern only changes gradually, as with the linear ramps just discussed, the deficit is always modest because the previously generated surface has done a good job of getting close to the required illuminance. The new surface will not have to scrunch the new source image, due to a tiny deficit, nor expand it wildly for a large deficit, because the target pattern is ‘tame’ (i.e., slowly varying) enough to prevent this.

This design method can be called ‘photometric non-imaging optics’, because of its utilization of photometric flux accounting in conjunction with reverse ray tracing to augment the edge-ray theorem of traditional non-imaging optics. So far only the size of the new increment of upper surface has been determined. Its slope must be determined as well, by a left-ray matching method to be disclosed next.

The iterative process that numerically calculates the shape of a particular illumination lens can begin, alternatively, at either the center or the periphery. If the lens diameter is constrained, the initial conditions would be the positions of the outer edges of the top and bottom surfaces. The design method would at the end totally determine the lens shape, in particular its central thickness. If this thickness should go below a minimum value then the initial starting points must be altered. In general, however, it is easier to begin the design iteration at the center of the lens using some minimum thickness criterion, e.g., 0.75 mm. The height of the lens center above the source would be the primary parameter in determining the overall size of the lens. The other prime factor is how the central part of the lens is configured, that is, as concave-plano, concave-concave, plano-concave, or convex-concave. Also, a concave surface can either be smooth or have the cusp-type center as shown in FIG. 8, in the case of a strong illuminance by scattering.

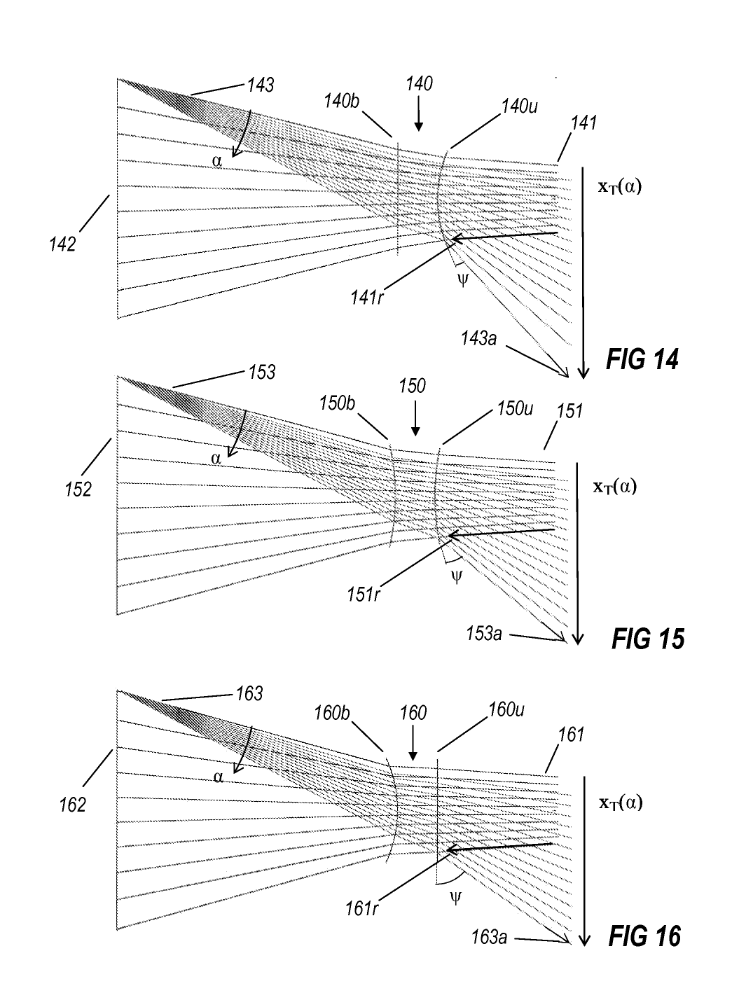

FIG. 14 shows concave-plano lens-center 140, to be used as a seed-nucleus for generating an entire illumination lens. Its diameter is determined by the width of ray fan 141, which propagates leftward from the target-center (not shown) x_{T}=0 at a distance of 23 mm above (to the right of) LED chip 142, its large size selected for clarity of presentation. Ray fan 141 is expanded by lens-center 140 so that it spans the full width of LED chip 142, but expands no further. This is how the lens-center delivers the proper size source-image to the target-center x_{T}=0.

In FIG. 14 upper surface 140u has radius of curvature of 3 mm and a center-height z_{U}=8 mm. Planar lower surface 140b has center-height z_{L}=7.25 mm. As discussed below, the surfaces with radius of curvature, such as upper surface 140u, are parabolas rather than spheres (customary in conventional geometric optics), because of their computational convenience in ray tracing.

All ray diagrams disclosed herein were generated by the commercial optical software package ASAP, from Breault Research, Inc. of Tucson Ariz. In ASAP this is done in two ways. One is the ASAP surface-type command ‘OPTICAL Z ZV. RC.-1 ELLIPSE RE.’, where ZV is the vertex height, RC the radius of curvature, and RE the radius of the elliptical base of shape. The other way is the edge-type command ‘POINTS’, followed by three triplets of x, y, and z coordinates, the first followed by ‘2’, the second by ‘1’, and the last by ‘0’. Then the ASAP command SWEEP produces a circularly symmetric surface from the parabolic profile. These surfaces are ray-traced by ASAP to make the Figures herein.

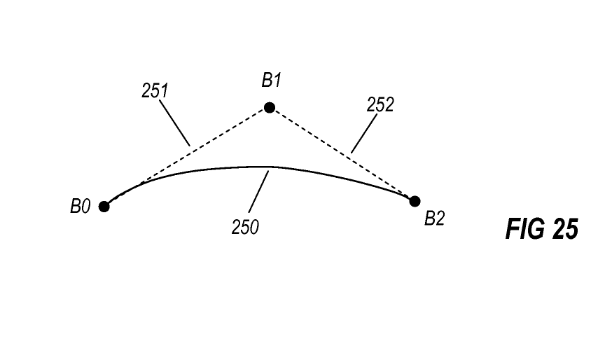

FIG. 25 shows the Bezier-curve method ASAP uses to make parabolas. Three points in space are specified by position vectors B0, B1, and B2, connected by dotted lines 251 and 252. Parabola 250 is tangent to the dotted lines, and can be parameterized by parameter t being zero at B0 and 1 at B2, with intermediate points described by

r(t)=(1−t)²B0+2t(1−t)B1+t²B2

Differentiating this gives the derivative vector r′, which gives the slope of the curve:

r′(t)=2[(t−1)B0+*1−2t)B1+tB2]

When the three points are not in a plane then r(t) is a space curve rather than a parabola. In ASAP the three coordinate triplets mentioned are those of the three defining point vectors B0, B1, and B2.

Ray fan 141 of FIG. 14 has the width necessary to achieve the desired illumination level at the center of the target, and in short-throw lighting this is less than what the LED would do by itself. This means the central part of the illumination lens must demagnify the source, which is why the lens-center is has a diverging optical power, with negative focal length. In fact, the very function of lens-center 140 is to provide the proper size of source image (of which ray fan 141 is a cross-section) for the target center, x_{T}=0. Inherent to short-throw illumination lenses is that this target-center source image is smaller than the actual LED itself, hence the lens-center is always diverging.

FIG. 14 also shows expanding ray fan 143, originating at the left edge of chip 142, so that these rays are all what can be termed left rays, each subtending its own value of the off-axis angle α. Each will mark the upper edge of a source image as seen from a unique lateral coordinate x_{T} on the target plane (not shown, but to the right). The rays of fan 143 go through the already established surfaces of lens-center 141 and then fan out towards the target, each with its unique value of lateral target-coordinate x_{T}, shown monotonically increasing downward as the off-axis angle α increases.

FIG. 15 shows concave-concave lens-center 150, with central ray-fan 151, chip 152, and left-ray fan 153. The lens surfaces have about half the curvature of the concave surface of FIG. 14. Lens-center 150 expands ray-fan 151 to cover chip 152 (identical to chip 142 of FIG. 14), with right ray 151r going to the edge of chip 152. Ray-fan 153 of left-rays spans increasing off-axis angle α to give rise to a monotonically increasing span of values for lateral target-coordinate x_{T}. Right ray 151r is the same as right ray 141r of FIG. 14, but the extreme left ray through arrow 153a lies at a slightly smaller value of off-axis angle α than for arrow 143a of FIG. 14, indicating a lower etendue for the lens-center, as will be discussed below.

FIG. 16 shows plano-concave lens-center 160, central ray-fan 161, chip 162, (identical to chip 142 of FIG. 14), and left-ray fan 163. Lens-center 160 expands ray-fan 161 to cover chip 162.

In the progression from FIGS. 14 to 16, the left ray going through the rightmost part of the lens-center, as indicated respectively by arrows 143a, 153a, and 163a, exits the lens-center at a growing exit-angle Ψ, indicating different illumination behavior and setting a different course towards the final design. All three configurations produce the same illuminance at target x=0, that is to say the same size source image there, as shown by the ray fans 141, 151, & 161 being of identical size as they arrive at each lens, which is equivalent to saying they produce the same target illuminance at center x_{T}=0. What is different is how rapidly the lateral coordinate x_{T} increases with off-axis angle α, as will be discussed below.

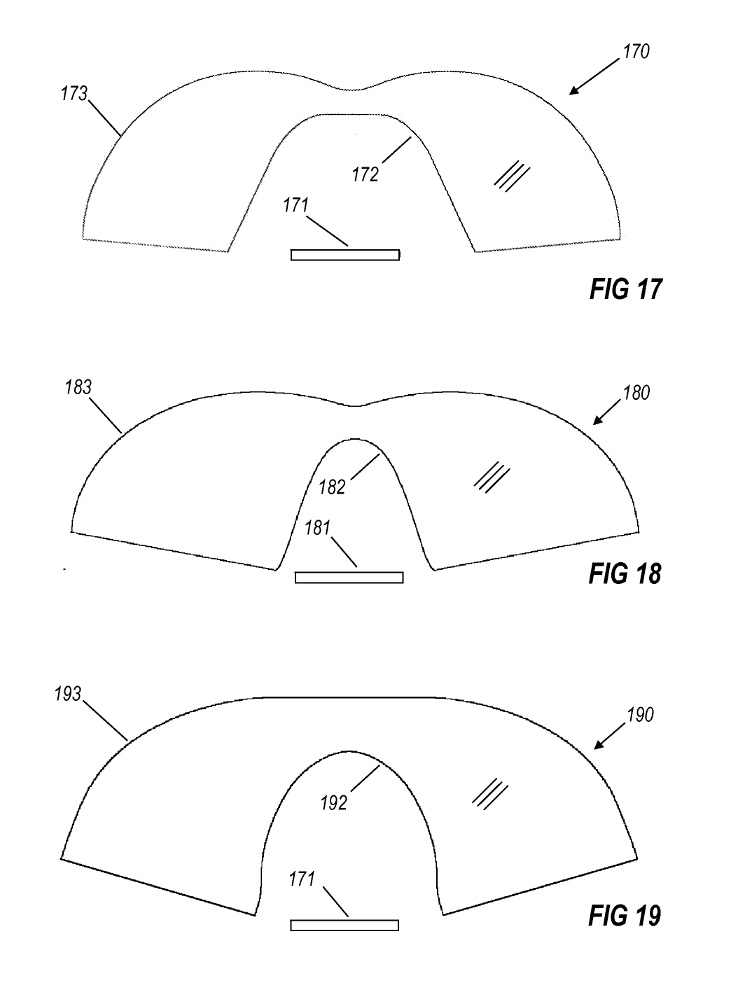

FIG. 17 shows illumination lens 170, numerically generated from a concave-plano center-lens, as in FIG. 14, by the design method disclosed herein. Planar source 171 is the light source for the design of surface profiles 172 & 173. Inner profile 172 completely surrounds source 171 and intercepts all its light. Outer profile 173 is generated as shown in FIG. 13A and FIG. 13B and further discussed below.

FIG. 18 shows illumination lens 180, numerically generated from a concave-concave center-lens, as in FIG. 15, by the design method disclosed herein. Planar source 181 is the light source from which it was designed and is identical to source 171 of FIG. 17. Inner profile 182 and outer profile 183 are shown.

FIG. 19 shows illumination lens 190, numerically generated from a plano-concave center-lens, as in FIG. 16, by the design method disclosed herein. Planar source 191 is the light source from which it was designed. Planar source 181 is the light source from which it was designed and is identical to source 171 of FIG. 17. Inner profile 192 and outer profile 193 are shown.

The triplet of successively differing lenses of FIGS. 17, 18, and 19 have different combinations of surface radii, each particular combination and any in between, achieve the same central result of demagnifying the source, because their lens-centers are all diverging, with the same negative focal length (as long as they have the same thickness). Where these lenses differ is in their differing treatment of the left rays of ray-fans 143, 153, and 163, respectively. After going through center-lens 140, ray-fan 143 has more divergence and spreads over a greater swath of lateral target-coordinate x_{T} than ray-fan 153 of FIG. 15, which in turn is greater than that of ray-fan 163 of FIG. 16. This greater divergence is seen in the successively smaller exit-angles Ψ of the rightmost rays through respective arrows 143a, 153a, and 163a. The radii of FIG. 14 were chosen because they produce a rather extreme value for Ψ of 70°. Because transmittance falls and distortion grows at such a high value of exit-angle Ψ, FIG. 14 arguably represents one extreme of this series. The other extreme, however, is not FIG. 16, because the upper lens surface can be convex as well.

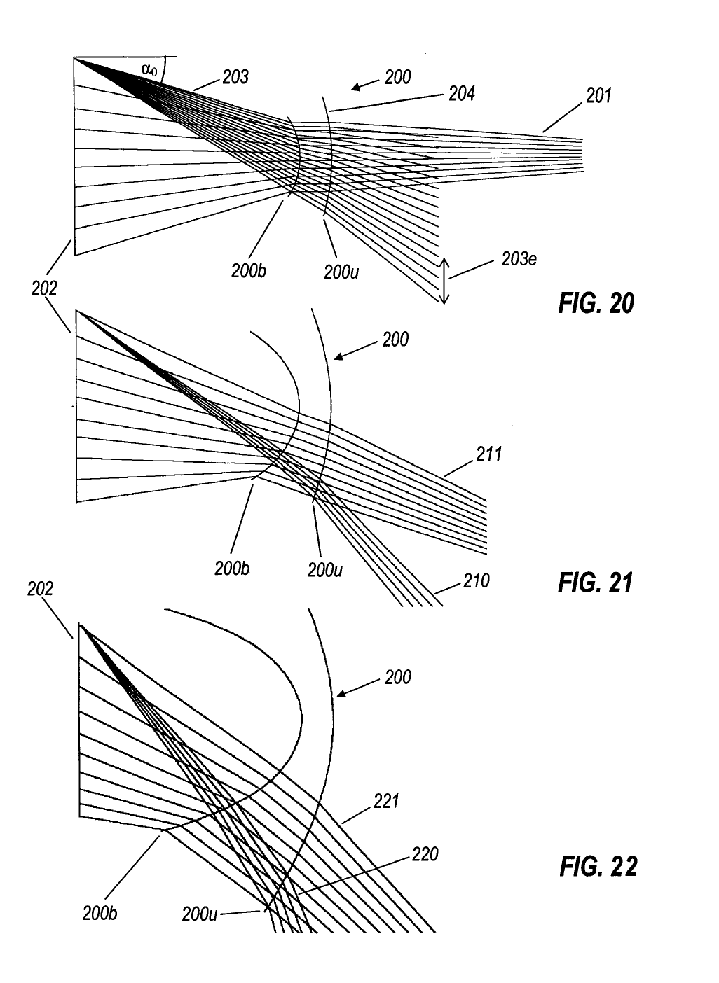

FIG. 20A shows concave-convex lens-center 200, in a set-up similar to those of FIGS. 14, 15, and 16. Lower surface 200b has a radius of curvature of 2 mm while for upper surface 200u it is −7 mm. As before, central ray fan 201 is expanded by lens-center 200 so that it just covers light source 202. As before, edge-ray fan 203 goes out through lens-center 200 and expands towards the target (not shown). This particular combination of radii was selected so that these left rays will have an even spacing when they reach the target, whereas for FIG. 14 their spacing increases greatly with off-axis angle α, less so in FIG. 15, and nearly even in FIG. 16. The exact definition of even spacing is defined by the illumination prescription the lens-LED combination is supposed to fulfill.

In FIG. 10, the cumulative distribution of encircled flux is graphed by dashed curve 107, representing the monotonically increasing cumulative function C(x_{T}). The definition of even spacing is more exactly given by matching it with the corresponding cumulative flux distribution represented by the increasing off-axis angle α in FIG. 20. A Lambertian emitter, such as the left edge of the light source 201, has an encircled flux distribution given by C(α)=sin²(α)−sin²(α₀), with α₀ as shown in FIG. 20A as the off-axis angle of the left ray that goes to x_{T}=0, the left most ray of fan 201. Every left ray is given the target destination coordinate x_{T} fulfilling C(α)=C((x_{T}). This process is shown in the progression of FIGS. 21, 22, and 23, illustrating the growth of lens 200 via an iteration that begins at the center of the target and proceeds outwards, as discussed in relation to FIG. 13.

Unlike the lens-centers in FIGS. 14-17, lens-center 200 in FIG. 20 is in the very next stage of the process, with upper surface 200u have been extended by segment 204, formed to intercept left rays 203e that go through lower surface 200b all the way to its edge, whereas in FIGS. 14-17 they only go to the edge of the upper surface (i.e., 140u, 150u, & 160u) and can be seen not to go through the entirety of the lower surface (i.e., 140b, 150b, & 160b). The new lens-segment 204 is a parabola curved such as to refract the left rays 203e to their proper destinations x_{T}(α). Next the lower surface 200b will be extended rightwards, as discussed next.

FIG. 21 shows a further stage of the design process, with a lens 200 now enlarged from FIG. 20. Left rays 205 were used to generate the outermost part of upper surface 200u, then ray-fan 211 is sent from xT=4 mm, not very far out on the target but already the lens is taking shape. Most of its rays go through already established surface to land as intended upon chip 201, but those going through the new surface established by ray fan 210 will need a new segment (for the sake of clarity not numbered) of lower surface, just to the right of rays 210, which can be seen to send the rest of ray fan 211 to source 201.

FIG. 22 shows yet a further stage, with lens 200 now big enough for full illumination at xT=20, from which rays 221 originate as the source image for that point on the target. Left rays 220 generate new upper surface, while the rays 221 are used to generate new lower surface, outboard of rays 220.

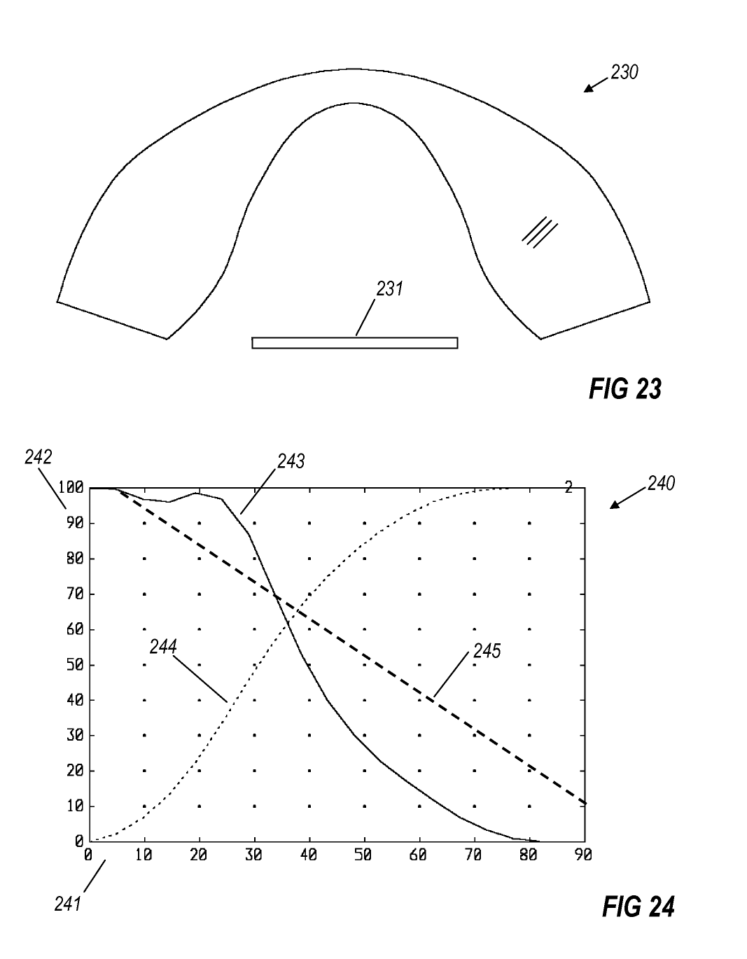

FIG. 23 shows the complete illumination lens 230 and LED source 231. FIG. 24 is the result of an ASAP Monte-Carlo ray-trace. Graph 240 has abscissa 241 corresponding to target coordinate x_{T} in mm and ordinate 242 corresponding to relative illuminance in per cent. Curve 243 is the ASAP output curve for relative illuminance. Dotted curve 244 is its cumulative distribution of encircled flux. Dashed line 245 is the ideal illuminance. It can be seen that curve 243 is at first above line 245, indicating excess illuminance, then below it, indicating deficient illuminance. This is an indication that the lens needs to be a little taller and wider in order to fully implement the prescription.

The issue of proper lens size can be analyzed in terms of etendue, which expresses how much ‘room’ light takes up as measured in phase space, which has one spatial dimension and one dimension that is the sine of the off-axis angle of a ray. The etendue of a planar Lambertian source of area A is

Eₛ=πA

The Lambertian source radiates into a cosine-projected unit-radius directional hemisphere, of area π rather than the 2π full area of the hemisphere. This etendue is spread out over the target, in proportion to the target area as weighted by relative illuminance I(x_{T}):

$${A}_{T} = 2 π {\int }_{0}^{R} I ( {x}_{T} ) {x}_{T} d {x}_{T}$$

The target etendue is given by E_{T}=A_{T}Ω₀
Here Ω₀ is the projected solid angle of the source image corresponding to I(x_{T})=1, as shown by source image 132 of FIG. 13A.

As light flows from the source through the lens to the target, etendue is conserved as long as there is no scattering. This means that a small lens will necessarily have wide-angle light issuing from its surface. If the angles of the light coming out of the lens are too broad, the lens will not be able to fulfill the prescription. In the design process this will become manifest when the required source image size, such as given by curve 106 in FIG. 10, is bigger than the lens. The result is as shown in FIG. 24, where curve 243 is at first higher than line 245, then below it.

The lenses of FIGS. 17, 18, 19, and 23 were designed by the method disclosed herein of utilizing rays from the periphery of the light source, which in this case is circular. The size of the lens is a free parameter, but etendue considerations dictate that a price be paid for a lens that is too small. In the case of a collimator, the output beam will be inescapably wider than the goal if the lens is too small. In the case of the short-throw illumination lenses disclosed herein, the result will be an inability to maintain an output illumination pattern that is the ideal linear ramp of curve 103 of FIG. 10, because it requires the source image of curve 106. If the lens is smaller than the required source image size, then it cannot supply the required illumination. Thus the lens size will be a parameter fixed by the goal of a linear ramp. Lenses that are too small will have some rays trapped by total internal reflection instead of going to the edge of the pattern. If this is encountered in the design process then the iteration will have to re-start with a greater height of the lens-center above the LED.

In conclusion, the preferred embodiments disclosed herein fulfill a most challenging illumination task, the uniform illumination of close planar targets by widely spaced lenses. Deviations from this lens shape that are not visible to casual inspection may nevertheless suffice to produce detractive visual artifacts in the output pattern. Experienced molders know that sometimes it is necessary to measure the shape of the lenses to a nearly microscopic degree, so as to adjust the mold-parameters until the proper shape is achieved. Experienced manufacturers also know that LED placement is critical to illumination success, with small tolerance for positional error. Thus a complete specification of a lens shape necessarily requires a high-resolution numerical listing of points mathematically generated by a fully disclosed algorithm. Qualitative shape descriptors mean nothing to computer-machined injection molds, or to the light passing through the lens. Unlike the era of manual grinding of lenses, the exactitude of LED illumination lenses means that without a numerical method of producing those lens-profile coordinates, there will be no lens.

The preceding description of the currently contemplated best mode of practicing the invention is not to be taken in a limiting sense, but is made merely for the purpose of describing the general principles of the invention. The full scope of the invention should be determined with reference to the Claims.

What is claimed is:

1. An illumination lens generally shown and described.
